(19) United States
(12) Patent Application Publication
(10) Pub. No.: US 2009/0117445 A1
(43) Pub. Date: May 7, 2009

(54) FUEL CELL SYSTEM

(75) Inventor: Shoji Sekino, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/293,212

(22) PCT Filed: Feb. 23, 2007
(86) PCT No.: PCT/JP2007/053423

§ 371 Date: Sep. 16, 2008

(30) Foreign Application Priority Data
Mar. 22, 2006 (JP) 2006-078847

(51) Int. Cl. H01M 2/12; H01M 2/02

(52) U.S. Cl. 429/34

(57) ABSTRACT

The present invention makes a power generation environment of a MEA uniform. A fuel cell system of the present invention includes a fuel cell stack having a plurality of fuel cells arranged on an identical plane, a housing configured to cover the fuel cell stack above a surface of said fuel cell stack through an airflow space, an airflow generating section configured to form airflow in said airflow space, and a blowing path provided such that exhaust gas exhausted from the airflow space is introduced into the airflow space again via the airflow generating section.

### TECHNICAL FIELD

The present invention relates to a fuel cell system, and especially relates to a planar stack type fuel cell system in which a plurality of fuel cells are arranged on an identical plane.

### BACKGROUND ART

A polymer electrolyte fuel cell includes a Membrane and Electrode Assembly (hereinafter to be referred to as MEA) having a structure in which a polymer electrolyte membrane is held between an anode and a cathode. A fuel cell of a type of directly supplying liquid fuel to the anode is referred to as a direct type fuel cell. In a power generation mechanism, the supplied liquid fuel is decomposed on catalyzer supported by the anode so as to generate protons, electrons, and intermediate products. Generated cations passes through the solid polymer electrolyte membrane to a cathode side and the generated electrons move to the cathode side through an external load. The power generation is performed while producing a reaction product through the reaction of the protons and electrons with oxygen in the atmosphere at the cathode. For example, in a direct methanol fuel cell (hereinafter to be referred to as a DMFC) using an aqueous methanol solution as the liquid fuel, the reaction shown by the following chemical formula (1) is perform at the anode and reaction shown by the following chemical formula (2) is performed at the cathode.

CH₃OH+H₂O→CO₂+6H⁺+6e⁻ (1)

6H⁺+6e⁻+3/2O₂→3H₂O (2)

Nowadays, research and development are advanced for application of the fuel cell system as a power source to various types of electronic apparatuses, particularly to a portable apparatus, since reduction in size and weight can be easily made in the polymer electrolyte fuel cell system using liquid fuel. Here, in case of using the fuel cell as a power source of an electronic device such as a PC, since an output of a single MEA is small so that a required voltage may not be attained, a plurality of fuel cells are connected (hereinafter, a minimum unit in the power generation of the fuel cell system is referred to as a fuel cell and an assembly of the fuel cells is referred to as a fuel cell stack). As the fuel cell system composed of a plurality of fuel cells, there are a bipolar type fuel cell system in which unit cells are stacked in a thickness direction of the fuel cell and a planar stack type fuel cell system in which unit fuel cells are arranged on a plane.

In case of an apparatus intended to be carried such as a laptop computer, the planar stack type fuel cell system of a thin structure is more suitable because of a restriction of the thickness. In the planar stack type, a plurality of fuel cells are arranged on a plane and the adjoining fuel cells are electrically connected by a collector, to attain a high voltage and a high output. When the planar stack type is employed, it is preferable that the entire fuel cell system is so small as to fit on a footprint of a portable apparatus.

By the way, it is required to constantly supply oxygen to the cathode in the fuel cell system. In the planer stack type fuel cell system, as a method of supplying oxygen, there are (A) a technique of mounting the fuel cell stack inside a housing and forcibly supplying air to a space between the housing and the fuel cell stack by using a small fan, and (B) a technique of opening a surface of the cathode to the atmosphere to allow the cathode to naturally perform intake of the air. However, the (B) structure of the natural intake type in which the surface of the cathode is exposed to the atmosphere cannot generate power when the surface of the cathode is coated. Therefore, a structure of housing the fuel cell system in the potable device is difficult to be employed. In addition, even when a housing only intended to house the fuel cell system is separately attached, it is required not to close air holes provided to the housing. On the other hand, in the (A) structure of housing the fuel cell system in a housing and forcibly blowing air with a compact fan, power can be stably generated unless an intake portion and an exhaust portion are closed. Accordingly, there are many advantages as a power source of the portable apparatus.

In order to incorporate the fuel cell system in the portable apparatus, the fuel cell system is required to be as small as possible. For this purpose, the fuel cell stack is required to be small and thin, and accordingly it is preferable that a distance between a cathode electrode of the fuel cell and an inside surface of the housing facing the electrode is as short as possible. However, in the fuel cell system consuming large power, the air has to pass through many fuel cells in a process of airflow through a space between the fuel cell stack and the housing. As a result, the fuel cell on a side near the intake portion is constantly exposed to fresh air in relatively low humidity and temperature, while the fuel cell on a side near the exhaust portion tends to be in high humidity and temperature since heat and moisture generated from many cathodes are fed.

Under this situation, the fuel cell under the power generation environment of low temperature and low humidity and the fuel cell under the power generation environment of high temperature and high humidity will coexist even in the identical fuel cell stack. When the temperature and humidity are ununiform, the flooding originating from a partial condensation easily occurs. Accordingly, in a plurality of fuel cells, a technique for equalizing the temperature and humidity to make the power generation environment uniform is desired.

To avoid the flooding, it can be considered to increase a flow amount of gas (oxidant gas) blown into a space between the fuel cell stack and the housing. However, fuel component reaching a cathode side from an anode side via the MEA, and cathode product water will be released to outside with the airflow. As a result, the fuel is wastefully consumed, and time for the power generation per unit amount of the fuel will be decreased. Thus, it is desired to provide a technique for making the power generation environment uniform without deteriorating generation efficiency.

In conjunction with the above description, in Japanese Patent Application Publication (JP-P2000-164229A) is described a temperature and humidity exchanging section adapted to perform temperature and humidity exchange, in order to prevent desiccation of the fuel cell, by contacting reacted gas that has passed through a cell reaction section with unreacted gas before passing through the cell reaction section via a porous body with water retentivity. At least one of the reaction gases passes through a mesh-shaped gas supply path of at least a single layer provided to contact a porous body.

In addition, Japanese Patent Application Publication (JP-P2004-14149A) discloses that oxygen in the air contacts a positive electrode by passing through air holes provided for a cover plate.

In addition, Japanese Patent Application Publication (JP-P2000-331703A) discloses a technique for effectively collecting and using water in the fuel cell. That is, in this related art, a section is adapted to liquefy vapor generated in an oxidation reaction of the fuel cell into condensation water by using a condensation section. A desalting section is provided to perform a desalting process on the condensation water. Also, a gas-liquid contacting section is provided on an exhausting and collecting line from an exhaust gas side of the fuel cell to the desalting section to make the air to be supplied to an air electrode of the fuel cell to contact the vapor or/and the condensation water before supplying to the fuel cell.

In addition, Japanese Patent Application Publication (JP-P2000-331699A) discloses a technique for providing a polymer electrolyte fuel cell system with small size, light weight, and high generation efficiency. That is, in this related art, a water condensation unit is provided to condense moisture included in cathode exhaust gas by introducing oxidant gas and the cathode exhaust gas exhausted from the cathode into a path for supplying the oxidant gas to the cathode and by performing heat exchange. Also, a gas-permeable water absorption member continuously provided to connect an outlet of the oxidant gas to an outlet of the cathode exhaust gas in the water condensation unit.

In addition, Japanese Patent Application Publication (JP-P2005-108713A) discloses a technique for providing a fuel cell able to stably generate power for a long time. That is, in this related art, a cathode flow path is branched to a plurality of branched flow paths and the branched flow paths are cooled by a cathode cooler, in order to efficiently collect water exhausted from an electromotive section and to reuse the water in a generating reaction.

In addition, Japanese Patent Application Publication (JP-P2003-282131A) discloses a technique for providing a DMFC cell pack able to smoothly supply air into a cell pack and to efficiently suppress inflow of foreign objects from outside. That is, in this related art, air channels are formed to each inside of an upper plate member and/or a lower plate member contacting cathode of the MEA. Thus, even when air supply is blocked at one of them because of a user and usage environment, the air is supplied through the air channel from other portions.

In addition, Japanese Patent Application

Publication (JP-P2004-241367A) discloses a technique for reusing product water produced in a cathode. That is, in this related art, a fuel cell has an MEA and a separator and a reaction gas flow path is arranged on a surface of the separator opposing to the MEA. A porous portion is formed in at least a part of the separator and a cooling gas flow path is formed on a back surface of the reaction gas flow path of the porous portion.

However, in any of the above mentioned related arts, reuse of moisture included in a cathode exhaust is not solved, even after achievement of reduction of use space required for a portable apparatus and low power consumption.

### DISCLOSURE OF INVENTION

Therefore, an object of the present invention is to provide a fuel cell system which can make power generation environment of a MEA uniform.

Another object of the present invention is to provide a fuel cell system in which power generation environment of the MEA can be made uniform after reducing a space required by a portable apparatus and achieving low electric power consumption.

Further another object of the present invention is to provide a fuel cell system in which moisture contained in cathode exhaust can be reused after reducing a space required by a portable apparatus and achieving low electric power consumption.

A fuel cell system according to the present invention includes: a fuel cell stack arranged with a plurality of fuel cells on an identical plane; a housing configured to cover the fuel cell stack via an airflow space; an airflow generating section including an airflow for supplying oxidant gas to each of the plurality of fuel cells in the airflow space; and a blowing path provided such that exhaust gas exhausted from the airflow space is introduced into the airflow space again via the airflow generating section.

According to the above described configuration, since containing cathode product water of the fuel cell stack, the exhaust gas exhausted from the airflow space is in high humidity. In addition, the exhaust gas is warmed with heat of a power generating reaction. By supplying the exhaust gas to the airflow space again via the airflow generating section, the fuel cells arranged at a position easily dried and easily cooled is humidified to keep its temperature.

Further in the present invention, the airflow space is opened to a stack intake opening section for taking oxidant gas into the airflow space and a stack exhaust opening section for exhausting the exhaust gas from the airflow space. A blowing path is provided to introduce the exhaust gas from the stack exhaust opening section via the airflow generating section into the airflow space again from at least a part of the stack intake opening section. The airflow space communicates with the blowing path at a part of the stack intake opening section and communicates with external atmosphere at another part of the stack intake opening section. The exhaust gas from the stack intake opening section and the external air are supplied from the stack intake opening section to the airflow space.

Moreover, the airflow generating section preferably includes a fan. In addition, the fan is preferably arranged in a planar direction of the fuel cell stack and in parallel with the fuel cell stack. When the fan is arranged in this manner, a space in a thickness direction can be reduced.

In addition, in another exemplary embodiment of the present invention, a plurality of fuel cells are arranged in a plurality of columns, and the airflow space is preferably divided by a partition for making an air flow uniform in the plurality of columns. Here, the blowing path is provided such that the exhaust gas exhausted from one of the plurality of columns is supplied to another of the plurality of columns via the airflow generating section.

Furthermore, in the above described fuel cell system, it is preferable that the airflow generating section includes a fan. Also, it is preferable that the airflow generating section, the fuel cell stack, and the blowing path are arranged on an identical plane, and the airflow generating section, the fuel cell stack, and the blowing path are housed in a single housing. Here, the airflow space on the fuel cells in one column communicates with the airflow generating section via the blowing path. In addition, the airflow generating section communicates with the airflow space on the cells for fuel cell in another column via the blowing path.

According to the present invention, the fuel cell system can be provided to make the power generation environment of the MEA uniform.

According to the present invention, the fuel cell system is provided to able to make the power generation environment of the MEA uniform, after reducing a space required by a portable apparatus and achieving low power consumption.

According to the present invention, the fuel cell system is provided to able to reuse moisture contained in cathode exhaust after reducing a space required by a portable apparatus and achieving low power consumption.

### BRIEF DESCRIPTION OF DRAWINGS

FIG. 1 is a view of a fuel cell stack of a fuel cell system according to a first exemplary embodiment of the present invention;

FIG. 2A is a top view showing the structure of a fan;

FIG. 2B is a side view showing the structure of the fan;

FIG. 2C is a perspective view showing the structure of the fan;

FIG. 2D is a perspective view showing the structure of the fan;

FIG. 3A is a top view showing the structure of an airflow generating section;

FIG. 3B is a side view showing the structure of the airflow generating section;

FIG. 3C is a perspective view showing the structure of the airflow generating section;

FIG. 3D is a perspective view showing the structure of the airflow generating section;

FIG. 4 is a view showing the structure of a duct;

FIG. 5 is a perspective view showing the structure of the duct;

FIG. 6 is a perspective view showing the structure of the duct;

FIG. 7 is a perspective view showing the structure of the duct;

FIG. 8 is a sectional view showing the structure of a fuel cell;

FIG. 9 is a top view of the fuel cell system according to a second exemplary embodiment;

FIG. 10 is a top view of the fuel cell system in a first comparison example; and

FIG. 11 is a diagram showing an experimental result.

### BEST MODE FOR CARRYING OUT THE INVENTION

Hereinafter, a fuel cell system 1 of the present invention will be described in detail with reference to the attached drawings.

### First Exemplary Embodiment

### (Configuration)

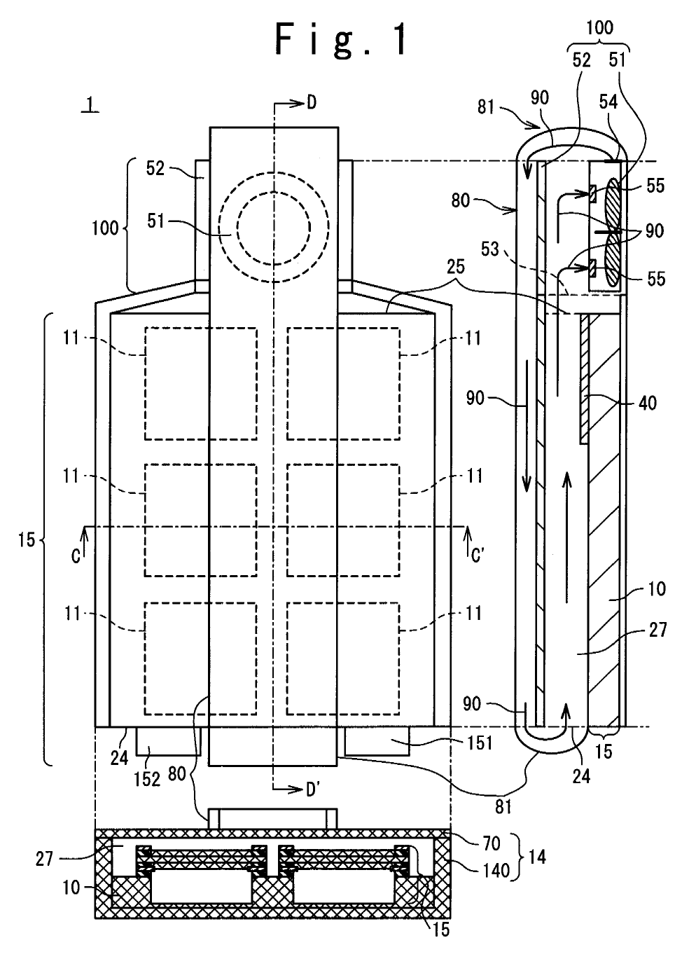

FIG. 1 is a schematic diagram showing a structure of a fuel cell system 1 according to a first exemplary embodiment of the present invention. In FIG. 1, a top view of a fuel cell stack 15, a sectional view along a DD′ line of the top view, and a sectional view along a CC′ line are shown. In the top view, although an internal configuration cannot be seen actually since it is covered with a housing and a duct, the internal configuration is shown visibly for simplification of description.

The fuel cell system 1 includes a fuel cell stack 15 in which a plurality of fuel cells 11 are arranged on a frame 10 on a plane, a housing 14 for housing the fuel cell stack 15, an airflow generating section 100 for forming airflow, and a duct 80. A space (an airflow space 27) is provided between the fuel cell stack 15 and the housing 14. The airflow space 27 communicates with the airflow generating section 100 at one end 25 and communicates with an inside of the duct 80 at another end 24. In addition, the inside of the duct 80 communicates with the airflow generating section 100. Accordingly, a blowing path 90 (an arrowed line in a sectional view along the line DD′) is formed which is connected to the another end 24 of the airflow space 27 from one end 25 of the airflow space 27 via the airflow generating section 100 and the inside of the duct 80. In addition, a fuel mother tank for storing fuel, a pump for flowing the fuel, and wirings for taking out electric energy are provided in the fuel cell system 1, which are not shown in the figure. Details of each of these components will be described below.

### (Entire Configuration)

The fuel cell stack 15 is configured by arranging a plurality of fuel cells 11 on the frame 10. In the present exemplary embodiment, six fuel cells 11 are arranged in a matrix of 2 columns×3 rows. A configuration of the fuel cell 11 will be described later, and all of the fuel cells 11 are arranged to orient their cathode surfaces upward (directed to an opposite side of the frame 10). In addition, the fuel cells 11 are connected in series in a column direction. A numeral 40 in the sectional view along DD′ shown in FIG. 1 represents a collector 40, which electrically connects between the columns of the fuel cells. All of the fuel cells 11 are electrically connected in series. Lead terminals 152 and 151 are connected to the fuel cell stack 15, and power is retrieved to outside via the lead terminals 151 and 152.

The housing 14 includes a housing body 140 and a lid 70. The housing 140 has a cross-section of a box shape with an opened upper portion, and includes a bottom plate on which the fuel cell stack 15 is mounted and two side plates standing from ends of the bottom plate. The bottom plate is of a rectangular shape corresponding to a shape of the fuel cell stack 15 in a matrix shape of 2 columns×3 rows. The side plates are provided to two opposed sides of the bottom plate, and the side plates are not provided for remaining two sides.

The lid 70 is arranged on the housing body 140 so as to be supported by the side plates of the housing body 140. The lid 70 and the fuel cell stack 15 do not contact to each other, and a space is provided. This space is the airflow space 27. The airflow space 27 contacts the cathodes provided to respective fuel cells 11 in the fuel cell stack 15. Accordingly, the air flowing through the airflow space 27 is supplied to the cathodes as oxidant gas. In addition, the airflow space 27 is opened at two portions where the side plates of the housing body 140 are not provided. The two opening portions are a stack intake opening section 24 for supplying the oxidant gas to the airflow space 27 and a stack exhaust opening section 25 for exhausting exhaust gas from the airflow space 27, respectively.

The lid 70 and the housing body 140 may be unified as one body. Or, they may be freely attachable and detachable separated type. A material of the lid 70 is preferably a metal such as stainless and aluminum as a base material so as to easily emit heat generated in the fuel cell stack 15, and its surface is preferably coated with an insulative vinyl. In addition, the lid 70 and an upper plate of the below-mentioned fan cover 52 are preferably in same height and as smooth as possible.

A configuration of the airflow generating section 100 will be described in detail. The airflow generating section 100 includes a fan 51 and the fan cover 52 covering the fan 51.

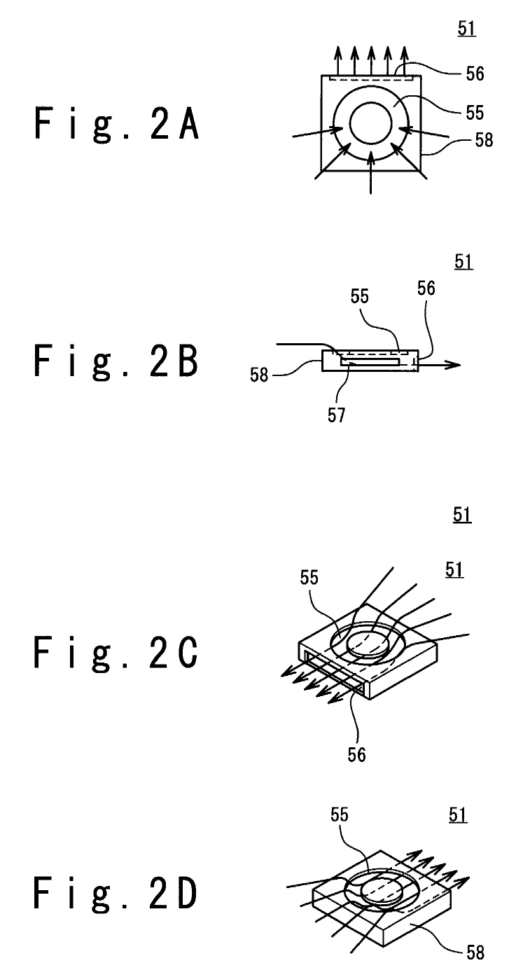

FIGS. 2A to 2D are diagrams showing a configuration of the fan 51. FIG. 2A is a top view of the fan 51, FIG. 2B is a side view, FIG. 2C is a perspective view seen from an oblique direction of an exhaust side, and FIG. 2D is a perspective view seen from an oblique direction of an inlet side.

As shown in FIGS. 2A to 2D, the fan 51 includes a fan body 57 (drawn only in FIG. 2B) and a fan support member 58 provided to cover the fan body 57 and support the fan body 57. The fan body 57 is in a blade shape and generates an air flow when rotating. The fan support member 58 includes a fan inlet 55 provided on a side of intake of an air flow when the fan body 57 rotates and a fan outlet 56 provided facing in a vertical direction to the fan inlet 55 on an air flow exhaust side of the fan 57. In such a configuration, the fan 51 inputs an air flow from its upper side (the fan inlet 55 side) and exhausts the air flow from its side (the fan outlet 56).

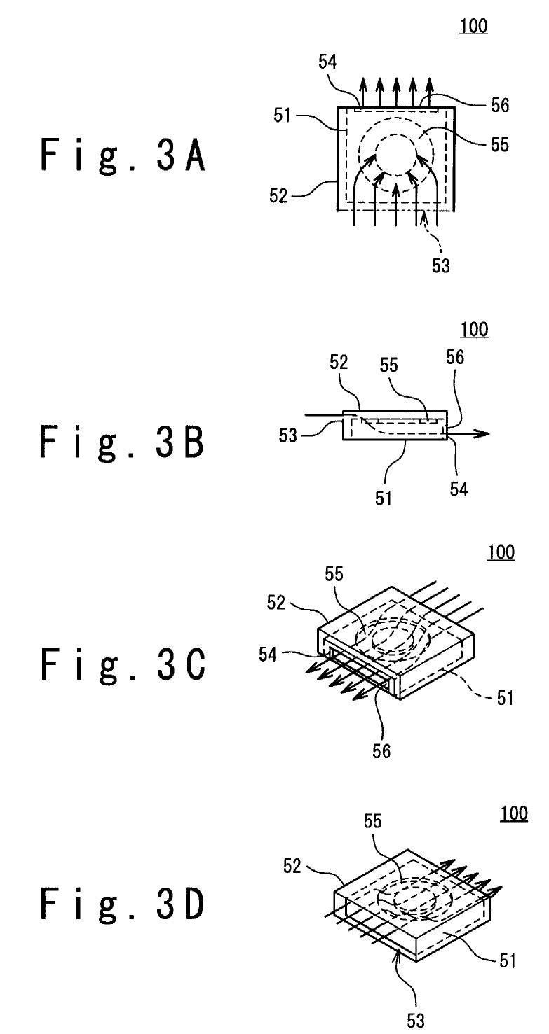

FIGS. 3A to 3D are diagrams showing states that the fan 51 is covered with the fan cover 52. That is, they are diagrams showing a configuration of the airflow generating section 100. FIG. 3A is a top view of the airflow generating section 100, FIG. 3B is a side view, FIG. 3C is a perspective view from an oblique direction on an outlet side, and FIG. 3D is a perspective view from an oblique direction on an inlet side. In FIGS. 3A to D, the fan 51 cannot seen actually since it is covered with the fan cover 52. However, the fan is drawn with being seen through for explanation.

As shown in FIG. 3B, the fan cover 52 is arranged to cover the upper surface of the fan 51 with keeping a small space. To a side portion of the fan cover 52, a fan cover inlet 53 and a fan cover outlet 54 are provided for opposite planes, respectively. The fan cover inlet 53 is connected to the space in an upper side of the fan 51. On the other hand, the fan cover outlet 54 is provided for a side plate corresponding to the fan outlet 56.

According to this configuration, the airflow generating section 100 takes an air flow from the fan cover inlet 53 and exhausts the air flow from the fan cover outlet 54. That is, the fan 57 itself absorbs an air flow from above and exhausts it downwards. However, the airflow generating section 100 is configured, as a whole, to absorb the air flow from the side and exhaust it from an opposite side to the absorption side in accordance with opening positions provided to the fan support member 58 and the fan cover 52.

Referring to FIG. 1 again, an arrangement of the airflow generating section 100 will be described. The airflow generating section 100 is arranged on the same plane with the fuel cell stack 15. Here, the fan cover inlet 53 is arranged so as to front to the stack exhaust opening section 25. Furthermore, a space between the stack exhaust opening section 25 and the fan cover inlet 53 is closed by a connection member. In these configurations, an exhaust gas exhausted from the stack exhaust opening section 25 is absorbed from the fan cover inlet 53 into the fan cover 52. The exhaust gas passing through the fan 51 is discharged to outside of the airflow generating section 100 from a side portion of the fuel cell stack 15 on an opposite side via the fan cover outlet 54.

As the airflow generating section 100, a sirocco fan, an axial flow fan, a cross-flow fan, and a turbo fan can be also used. Considering a case of mounting the fan to the portable apparatus, a fan such as a thin radial flow fan consuming low electric power is preferable.

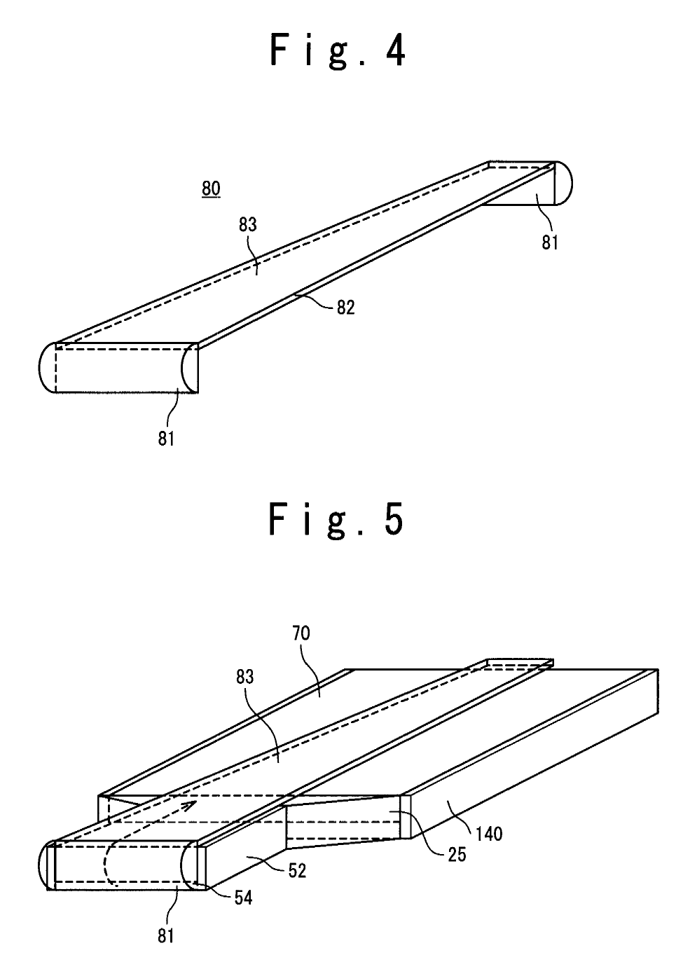

Subsequently, the duct 80 will be explained. FIG. 4 is a perspective view showing a shape of the duct 80. The duct 80 is formed of a duct body 83 and guides 81. The duct body 83 is formed of a rectangular member and duct side walls 82 provided for two opposed sides. The guides 81 are connected to remaining two sides of the rectangular member, respectively, and extends downwards so as to draw a circular arc. Moreover, in the guide 81, a side wall is provided to a portion corresponding to a position of the duct side wall 82.

Referring to FIG. 1 again, the duct 80 with the above-mentioned configuration is arranged on the upper surface of the lid 70 of the duct body 83 and the fan cover 52. A length of the duct 80 in a longitudinal direction is the same as a length combining lengths of the lid 70 and the fan cover 52. A space is formed between the duct 80 and the lid 70 for the thickness of the duct side wall 81. The space between the duct 80 and the lid 70 is connected to the fan cover outlet 54 by the guide 81 provided on the side of the fan cover 52. In addition, the space is connected to a part of the stack intake opening portion 24 by the guide 81 provided on the side of the stack intake opening portion 24.

FIG. 5 is a perspective view for explanation of an arrangement of the duct 80 seen from the fan cover 52 side. In FIG. 5, an arrowed line shows a flow direction of the exhaust gas. For convenience of explanation, a part of the fan cover 5 is shown with being seen through. When the guide 81 is arranged on the side section of the fan cover 52, the inside of the fan cover 52 communicates with a space (formed by the duct 83 and the lid 70) in the duct body 83 via the guide 81. That is, the exhaust gas exhausted from the fan cover outlet 54 returns to the guide body 83 side passing through the guide 81.

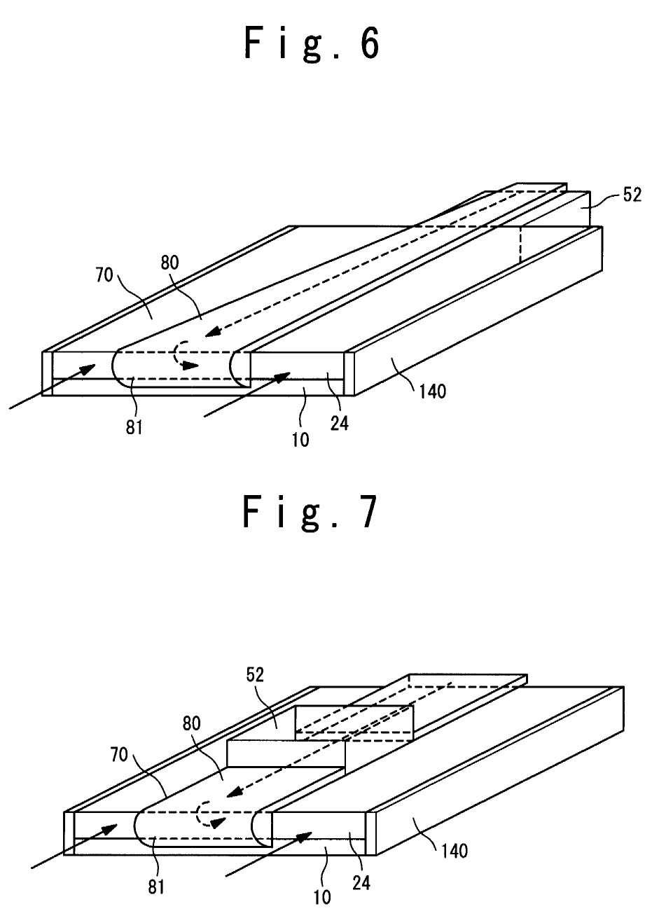

FIG. 6 is a perspective view for explanation of the arrangement of the duct 80 seen from the stack intake opening portion 24 side. Similar to FIG. 5, an arrowed line shows a flow direction of the exhaust gas. For convenience of explanation, a part of the fuel cell stack 15 is shown with being seen through. The exhaust gas flowing through the duct 80 is returned by the guide 81, and is introduced from the stack intake opening portion 24 into the airflow space 27. Meanwhile, the guide 81 is not provided so as to completely cover the stack intake opening portion 24 but is connected to a part of the stack intake opening portion 24. Accordingly, the air from outside is also taken from the stack intake opening portion 24 in addition to the exhaust gas flowing in the duct 80.

According to the above-mentioned configuration, as shown by the sectional view along line DD′ in FIG. 1, when the airflow generating section 100 generates air flow, the air in the airflow space 27 is exhausted to the duct 80 via the airflow generating section 100 and is further introduced from the stack intake opening portion 24 to the airflow space 27. Accordingly, the blowing path 90 is formed to supply the exhaust gas exhausted from the fuel cell stack 15 to the fuel cell stack 15 again.

The exhaust gas resupplied to the airflow space 27 via the blowing path 90 has high humidity because containing product water produced at the cathode of the respective fuel cells 11. In addition, the gas is warmed because passing on the heating fuel cell stack 15. Since this exhaust gas is resupplied from the stack intake opening portion 24, the fuel cells 11 which becomes easily dry and is cooled to a low temperature, in the vicinity of the stack intake opening portion 24 (an upper stream side), can be humidified and warmed. Thus, the power generation environment of the fuel cells 11 in the upper stream side and the fuel cells 11 in the lower stream side can be made uniform from the view point of temperature and humidity.

Meanwhile, the duct body 83 may be in a cylindrical shape and may have a configuration where exhaust gas passes inside. However, a configuration where the duct body 83 is mounted on the lid 70 as described above and the lid 70 functions as a bottom plate of the blowing path 90 is more preferable since temperature inside the duct 80 can be closer to temperature of the airflow space 27. In addition, it is preferable for reduction of thickness.

As materials of the duct body 83, a plastic plate or a metal plate can be used, for example, but it is not limited to them. However, since the exhaust gas with high humidity passes, its surface is preferably coated by vinyl and the like when the metal plate easily corroded in the condensation is used.

As for the duct side wall 82, the same material as the duct body 83 may be used, and for example, a simple structure may be employed in which an airtight material such as urethane material with the thickness of approximately 0.1 to 1.0 mm is cut to be in a band shape with the width of approximately 0.5 to 3.0 mm and the bands are attached to a flat plate forming the duct body 83. When the urethane material is used, it is also possible to make it to absorb dew condensation water in the duct 80 to prevent the exhaust gas flow from stopping, by using a material with water absorbability. In addition, even if the duct side wall 82 does not have airtightness, effectiveness of the duct 80 can be obtained when caulked by an airtight tape from outside. Furthermore, a portion with no duct side wall 82 may be partially provided and a portion for taking the outside air into the blowing path 90 may be provided. Thus, it can be avoided that humidity of the exhaust gas unnecessarily increases and the dew condensation can be prevented. As described above, as the duct side wall 82, functions of the materials can be utilized as necessary.

As for the guide 81, plastic materials such as comparatively soft vinyl chloride hard to be folded and deformed in being rolled are suitable. Meanwhile, it is not limited to the plastic materials such as the vinyl chloride. In addition, the basic structure is employed in which a plate material is rolled in a circular arc shape and its sides are caulked with a tape. However, the shape is not also limited to the shape described here. It is enough to employ a shape and a structure in which the air passing on the cathode 31 surface of the fuel cell stack 15 (the exhaust gas exhausted from the airflow space 27) is introduced into the duct 80 and is further resupplied to the air flow space 27 again from a part of the stack intake opening portion 24.

In addition, the exhaust gas exhausted from the airflow space 27 is not required necessarily to be supplied to the fuel cell stack 15 via the duct. There are clearances between the guide 81 and the fan cover outlet 54 and between the guide 81 and the stack intake opening section 24. The clearances may be configured to exhaust a part of the exhaust gas passing through the blow path 90 to outside air as needed. Especially, when the air is blown from the duct 80 to the stack intake opening section 24, the entire exhaust gas passing through the duct 80 is not necessarily required to be introduced to the stack intake opening section 24 and a structure which a part of the exhaust gas from a clearance of the guide 81 is constantly discharged may be employed.

In addition, when the stack intake opening section 24 is configured to be completely covered with the guide 81, the fresh air from outside will not be supplied. For this reason, the guide 81 is provided to cover only a part of the stack intake opening section 24. A rate of a coverage area by the guide 81 to the entire area of the stack intake opening section 24 is not limited specifically and is appropriate to approximately 5 to 80%. Furthermore, when the cathode exhaust gas is resupplied to the fuel cells 11, the power generation environment can be optimized by relatively reducing an allocation of the guide 81 to a row of fuel cells 11 including the fuel cell 11 having the cathode 31 whose temperature easily rises because of influence of the fuel supply path and by increasing the allocation of the guide 81 to a row of the fuel cells 11 whose temperature is hard to rise and whose humidity in the airflow space easily decreases.

A cross-sectional shape of the duct body 83 is preferably a shape to bring an effect in utmost limitation of a thickness such as a rectangular shape. However, it is not limited specifically since a plurality of small cylindrical structure can be employed when there is a limitation depending on an internal structure of a portable apparatus. In addition, the cross-sectional area may be increased and decreased gradually in consideration of a flow speed and humidity of the exhaust gas in an internal space of the duct 80. Moreover, in consideration of dew condensation in the duct 80, a structure may be employed in which a mesh of plastics is attached inside the duct 80 so that condensed water does not prevent a flow of the cathode exhaust gas inside the duct 80, and in this case, an effect that the condensed water spreads along the mesh can also achieved. It is also effective that the mesh is attached to the inside of the guide 81, and it is also possible to return the dew condensation water to a fuel system through the guide 81. The mesh of plastics or metals can be used. The size of the mesh is not limited specifically, but meshes of 40 to 200 are preferable. Furthermore, by using a material with a water absorbability, an air flow due to the dew condensation in the duct 80 can be suppressed.

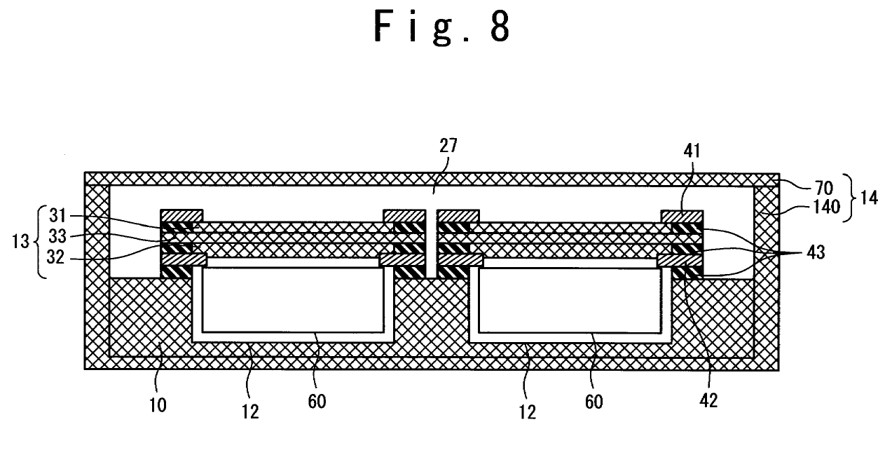

The space in the thickness direction can be reduced by arranging the airflow generating section 100 on the identical plane to the fuel cell stack 15. However, the arrangement on an identical plane is not necessarily required when there is a wide space in the thickness direction. FIG. 7 shows a modification of the arrangement of the airflow generating section 100. In the modification shown in FIG. 1, the airflow generating section 100 (the fan cover 52) is arranged on the lid 70. As mentioned above, the airflow generating section 100 may be arranged at an upper side of the fuel cell stack 15. In addition, the airflow generating section 100 may be arranged to be embedded inside the duct 80. Furthermore, in a system blowing the air in a positive pressure, the airflow generating section 100 may be arranged not to the stack exhaust opening section 25 side but to the stack intake opening section 25 side.

Meanwhile, in the present exemplary embodiment, a case has been described in which the air is absorbed in the airflow space 27 since the airflow generating section 100 is in a negative pressure to the airflow space 27. However, a configuration may be employed in which the airflow generating section 100 is in a positive pressure and delivers the air into the airflow space 27. That is, a direction of the blowing may be reversed by arranging the fan 51 upside down. When such a configuration is employed, it is obvious to the person skilled in the art that at least a part of the exhaust gas from the airflow space 27 can be returned into the airflow space 27 again and a warming and humidification effect can be achieved.

### (Fuel Cell)

Subsequently, details of a configuration of the fuel cell 11 will be described. FIG. 8 is an enlarged cross-sectional view along the line CC′ in FIG. 1. That is, the configuration of the fuel cell 11 is drawn in detail in FIG. 8. The fuel cell 11 includes an MEA 13, a cathode power collector 41, an anode power collector 42, a fuel tank section 12, and a plurality of seal members 43.

As described above, the fuel tank section 12 is a concave portion provided to the frame 10. Liquid fuel (an aqueous methanol solution) supplied to the MEA 13 is stored in the fuel tank section 12. In addition, a wicking member 60 is inserted to the fuel tank section 12. The wicking member 60 is inserted for the purpose of assist of fuel supply. As a material of the wicking member 60, urethane form is exemplified. Meanwhile, when the fuel is stably supplied to the MEA, the wicking member 60 is not necessarily required.

The MEA 13 is arranged to cover an upper opening of the fuel tank section 12. The MEA 13 is of an approximately square shape. The MEA 13 includes a polymer electrolyte membrane 33, an anode 32, and a cathode 31. The anode 32 is arranged on one surface of the polymer electrolyte membrane 33 and the cathode 31 is arranged on the other surface thereof. The polymer electrolyte membrane 33 is sandwiched by the anode 32 and the cathode 31.

The MEA 13 is arranged for the anode 32 to orient downwards (the fuel tank section 12 side). The anode power collector 42 is arranged on a periphery portion of the MEA 13 on the anode 32 side and the cathode power collector 41 is arranged on a periphery portion thereof on the cathode 31 side. The anode power collector 42 and the cathode power collector 31 are of a frame shape. The anode power collector 42 and the cathode power collector 41 are arranged to sandwich an end portion of the MEA 13. That is, the anode 32 is connected to the fuel tank section 12 at a central portion in the inside from the anode power collector 42. In addition, the cathode 31 is connected to an upper space at a central portion in the inside from the cathode power collector 41. Here, the upper space of the cathode 31 is the airflow space 27.

The seal member 43 is arbitrarily arranged to caulk gaps among the respective components. Because of the seal member 43, the liquid fuel does not leak from the fuel cell 11.

In such a configuration, the liquid fuel stored in the fuel tank section 12 is supplied to the anode 32. On the other hand, the air is supplied from the airflow space 27 to the cathode 31. Power generation reaction occurs accordingly and the generated power is retrieved from the anode power collector 42 and the cathode power collector 41.

It should be noted that the MEA 13 can be obtained by arranging a carbon or a metal conductive sheet electrode to which a carbon-based catalyst layer is applied, so as to direct the surface to which the carbon-based catalyst layer is applied toward the polymer electrolyte membrane 33. In addition, the fuel cell 11 can be obtained by sandwiching the MEA 13 by two power collectors from the both surfaces and by securing the cell on the frame 10 so as to direct the anode 32 toward the fuel tank section 1.

As for the polymer electrolyte membrane 33, its material is not limited if the membrane conducts protons. In addition, as for catalyst layers of the cathode 31 and the anode 32, an electrode carrying a catalyst metal consisting primarily of platinum fine particles can be used. Especially, as for the anode 32 side, it is preferable to carry another metal component such as ruthenium with platinum in order to avoid poisoning of carbon monoxide. Furthermore, when the MEA 13 is mounted on the frame 10, the MEA 13 including the power collectors can be secured by screws and an adhesive. Meanwhile, the securing method is not limited to them.

As for the fuel supply to the anode 32, a direct-liquid method for directly supplying the liquid fuel has been described. However, a method such as vaporization supply via the PTFE (polytetrafluoroethylene) and the like may be used. A fuel supply method to the anode 32 side is not limited only to the method described here.

By arranging a plurality of fuel cells 11 and electrically connecting the power collectors to each other, the fuel cell stack 15 is formed.

As described above, when the fuel cell system 1 according to the first exemplary embodiment is used, the fuel cell easily dried and cooled relatively can be humidified and warmed by delivering the exhaust gas from the airflow space 27 to the airflow space 27 again via the airflow generating section 100. That is, the power generation environments among the fuel cells 11 are made uniform in temperature and humidity.

As a result, since the cathode product water and fuel volatilization through the MEA can be suppressed, power generation efficiency per used fuel increases. In addition, by warming, it is possible for the fuel cell stack 15 to output the power after rising of its temperature. Furthermore, it is possible to collect a fuel component through the duct 80.

At this time, since the airflow generating section 100 is arranged in the middle of a circulation path of the exhaust gas, energy required by the airflow generating section 100 to generate an air flow can be little. Thus, reuse of the exhaust gas is achieved at low power consumption.

In addition, since the space in the thickness direction is reduced when the airflow generating section 100 is arranged in a planar direction of the fuel cell stack 15, it is advantageous for a power source of a portable apparatus.

### Second Exemplary Embodiment

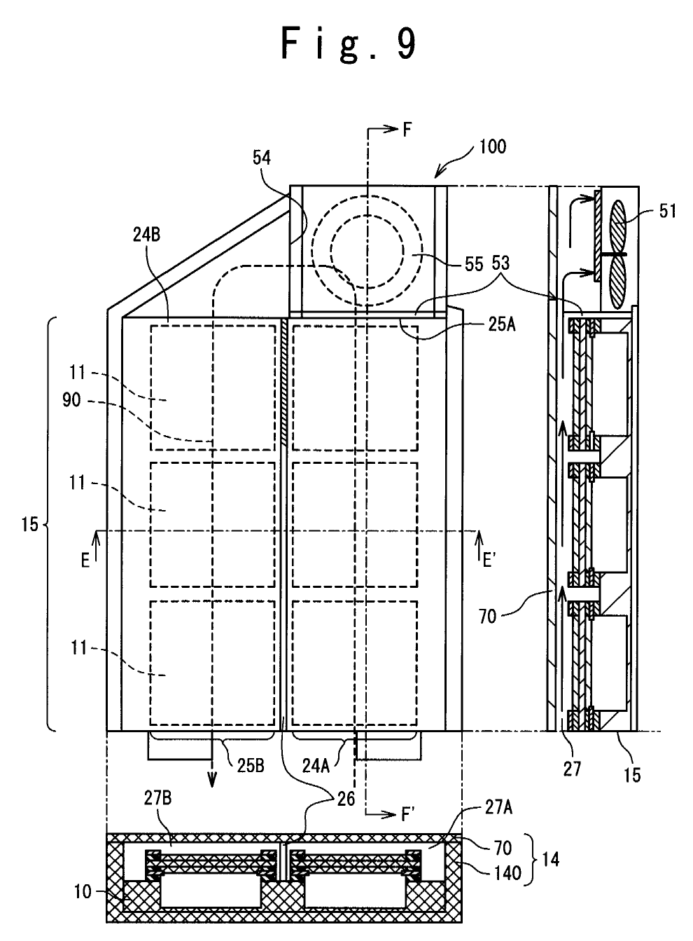

Next, the fuel cell system 1 according to a second exemplary embodiment of the present invention will be described. FIG. 9 is a diagram showing a configuration of the fuel cell system 1 according to the present exemplary embodiment. Compared to the first exemplary embodiment, the second exemplary embodiment is different from the first exemplary embodiment in that the duct 80 is not provided and that a partition 26 is provided in the airflow space 27. A configuration of the fuel cell 11 is the same as that of the first exemplary embodiment and its explanation will be omitted.

The partition 26 is installed to divide columns of the fuel cells 11 arranged in a matrix of 2 columns×3 rows. By the partition 26, the airflow space 27 is divided into a first airflow space 27A and a second airflow space 27B.

The partition 26 is formed of a material able to make a flow of the air uniform. That is, an air flow is divided by the partition 26 in the first airflow space 27A and the second airflow space 27B. According to this, the first airflow space 27A and the second airflow space 27B respectively have independent stack intake opening sections 24A and 24B and stack exhaust opening section 25A and 25B. That is, one opening section is divided into the stack intake opening section 24A and the stack exhaust opening section 25B, and another opening section is divided into the stack exhaust opening section 25A and the stack intake opening section 24B.

If an air flow can be roughly divided, the partition 26 is not required to completely divide the air flow. Urethane form material can be exemplified as such a material. Since heat can be exchanged between columns of fuel cells 26 via the partition 26 when the partition 26 has air permeability, a temperature distribution in the fuel cell stack 15 can be made uniform.

The airflow generating section 100 is arranged to be adjacent to the fuel cell stack 15 at the stack exhaust opening section 25A. The airflow generating section 100 is provided on an identical plane to the fuel cell stack 15. In the airflow generating section 100, directions in which the fan cover outlet 54 and the fan outlet 56 (not shown in FIG. 9) are provided are changed compared to those of the first exemplary embodiment. In the present exemplary embodiment, the fan cover outlet 54 and the fan outlet 56 are provided to be faced in a direction orthogonal to a direction of the fan cover inlet 53. That is, the exhaust gas flowing in the first airflow space 27A changes its flowing direction by 90° in a planar direction in the airflow generating section 100.

A gap between the fan cover outlet 54 and the stack intake opening section 24B is a closed space because a connecting member is provided. The airflow generating section 100 communicates with the stack intake opening section 24B on an exhaust side via the closed space.

In addition, the airflow space and an upper portion of the closed space (in a thickness direction) are covered with the lid 70.

In FIG. 9, arrowed lines show a flow direction of airflow (the blowing path 90). When the airflow generating section 100 is driven, the air is supplied from the stack intake opening section 24A into the first airflow space 27A. The exhaust gas from the first airflow space 27A is supplied to the second airflow space 27B via the airflow generating section 100 and the stack intake opening section 24B. The gas flowing through the second airflow space 27B is exhausted to outside via the stack exhaust opening section 25B.

According to the present exemplary embodiment, since the exhaust gas humidified and warmed in the first airflow space 27A is supplied, desiccation and cooling can be avoided in the fuel cells 11 in the vicinity of the stack intake opening section 24B of the second airflow space 27B.

In addition, since the duct 80 is not provided in the thickness direction, a space in the thickness direction can be further reduced compared to the first exemplary embodiment. It is further advantageous to a power source of a portable apparatus requiring the reduction of the space.

It should be noted that in the present exemplary embodiment, the space between the airflow generating section 100 and the stack intake opening section 24B has been described as a closed space. However, the air is inlet from outside by partially opening the space to absorb the fresh air (the air including large amount of oxygen) as needed. When at least a part of the exhaust gas is supplied from the first airflow space 27A to the second airflow space 27B, a warming and humidification effect can be achieved on an upper stream side of the second airflow space 27B.

### EXPLANATION OF EXAMPLES

The present invention with will be described by using experimental results and comparison examples.

### First Example

A fuel cell system used in a first example has a configuration shown in FIG. 1. A structure of the fuel cell will be described below. At first, catalyst-carrying carbon fine particles which hold platinum fine particles with the particle diameter within a range from 3 to 5 nm at 50% ratio by weight on carbon particles (ketjen black EC600JD manufactured by LION Co.) was prepared. By adding Nafion solution (name of commodity; DE521, the “Nafion” is a registered trade mark of Dupont Co.) of 5% by weight into the catalyst-carrying carbon fine particles of 1 g and agitating the solution, catalyst paste for forming a cathode was obtained. By coating the catalyst paste on carbon paper (TGP-H-120 manufactured by Toray Co.) as a substrate in a coating amount from 1 to 8 mg/cm² and drying it, the cathode 31 of 4 cm×4 cm was manufactured. On the other hand, a catalyst paste for forming an anode was obtained under a same condition as in obtaining the catalyst paste for forming the above-mentioned cathode except to use platinum (Pt)-ruthenium (Ru) alloy fine particles (a ratio of Ru is 50 at %) with a particle diameter within a range from 3 to 5 nm in stead of the platinum fine particles. Except for the use of the catalyst paste, the anode 32 was made under a same condition as in making the above-mentioned cathode.

Next, a membrane of 8 cm×8 cm×180 μm (thickness) formed of Nafion 117 of Dupont Co. (250000 number average molecular weight) was prepared as the polymer electrolyte membrane 33. The above-mentioned cathode 31 was arranged on one surface of the membrane in a thickness direction so that the carbon paper was on the outermost side. The above-mentioned anode 32 was arranged on the other surface so that the carbon paper was on the outermost side. Then, they were hot-pressed from the outsides of the carbon papers. Thereby, the MEA (Membrane and Electrode Assembly) 13 was obtained in which the cathode 31 and the anode 32 were joined to the polymer electrolyte membrane 33.

Next, the power collectors 41 and 42 of the rectangular frame shape plate formed of stainless steal (SUS316) and of 6 cm×6 cm×1 mm, and 11 mm of width were arranged on the cathode 31 and the anode 32. It should be noted that a seal member 43 of a rectangular frame shape member formed of silicon rubber and having the outer size of 6×6 cm², 0.3 mm of thickness, and 10 mm of width was arranged between the polymer electrolyte membrane 33 and the anode power collector 42. In addition, between the polymer electrolyte membrane 33 and the cathode power collector 41, a seal member 43 of a rectangular frame shape member formed of silicon rubber and having the outer size of 6×6 cm², 0.3 mm of thickness, and 10 mm of width were arranged also as other seal member. Portions of the polymer electrolyte membrane 33 protruding outside the power collectors 41 and 42 were cut off.

As the frame 10 of the fuel cell system 1, a frame formed of acrylic and having the outer size of 19.5 cm×14.5 cm×1 cm was used. Six concave portions were formed as fuel cell tank sections 12 inside the frame 10 so that the fuel cells 11 can be arranged in a matrix shape of 2 columns×3 rows. A flow passage structure was employed in which the fuel was supplied from the stack fuel inlet 21 and then exhausted from the stack fuel outlet 22 after passing through all of the fuel cells 11. The respective fuel tank sections 12 were containers having the inner size of 4 cm×4 cm and 5 mm, and a wicking member 60 formed of urethane material was inserted into the fuel tank section 12 as a fuel keeping material.

The MEA 13, the cathode power collector 41, the anode power collector 42, and the seal members 43 were arranged on the above-mentioned fuel tank sections 12 and they were screwed and unified by a predetermined number of screws. Thus, the fuel cell stack 15 was attained as an assembly of the fuel cells 11 and the cells 12 according to first exemplary embodiment.

The adjoining fuel cells 11 were electrically connected in series via the power collectors. In FIG. 1, a minus terminal 152 was drawn from a left below portion of the fuel cell system and a plus terminal 151 was drawn from a right below portion of the fuel cell system.

The fuel cell stack 15 formed as described above was placed on a housing 14 formed of aluminum and having a bottom plane of the size of 1 mm thickness×20 cm depth×15 cm width. The surface of the aluminum housing 14 was insulated by attaching a polypropylene adhesive sheet. Both sides in a short side direction were bent to function as side plates as shown in FIG. 1, and an upper portion of the fuel cell stack was covered with the lid 70.

When the fuel cell stack 15 is covered with the housing 14 and the lid 70, opening portions are formed above and below the fuel cell stack. In this opening portion, a distance between the cathode 31 and the lid 70 was approximately 1.2 mm. By introducing the air from one of the opening portions formed as described above, that is, one side of the airflow space 27 and exhausting the air from the other, the airflow can be formed on the surface of the cathode 31 of the fuel cell 11. In addition, the airflow can be made uniform by using the small fan 51 and covering with the fan cover 52 having two opening portions of the fan inlet 55 and the fan outlet 56.

No step existed at an upper surface connecting portion between the fan cover 52 and the lid 70. In addition, a plastic tape was attached to the connecting portion for airtightness. Then, as shown in the sectional view in FIG. 1, the duct 80 was mounted on the fan cover 52 and the lid 70. As a duct side wall 82, urethane material with the thickness of 0.5 mm was cut in a width of 1.0 mm and the airtightness was applied. Two guides 81 were connected to the fan cover outlet 54 and the stack intake opening section 24, respectively. The guide 81 was bent in a circular arc shape as shown in FIG. 1 (the sectional view along the line DD′) and the sides were caulked by a tape.

As described above, a structure was employed in which the fresh air was absorbed from the stack intake opening section 24 to which the guide 81 was not allocated and the cathode exhaust passing the cathode 31 was resupplied through the duct 80.

### Second Example

A structure of the fuel cell system used in a second example will be described below. A manufacturing method and a structure of the MEA are the same as those of the first example, and the structure of the fuel cell stack 15 is also the same as that of the first example. Other conditions are also the same if not mentioned especially below.

As for the second example, opening portions were provided to a part of the duct side wall 82. Specifically, four notches were provided in total at 4-dividing portions of the duct 80, by two on one side. The width of the notch was 2 mm.

### Third Example

The structure the fuel cell system used in a third example will be described below. The manufacturing method and the structure of the MEA are the same as those of the first example, and the structure of the fuel cell stack 15 is also the same as that of the first example. Other conditions are also the same if not mentioned specifically below.

As for the third example, the fan 51 was mounted at a central portion of the duct 80. Since a speed of the air flowing through the airflow space 29 is slow in case of this configuration, a flow amount in power generation was 1.5 time as much as the first and second examples.

### Fourth Example

The structure of the fuel cell system used in a fourth example will be described below. The manufacturing method and the structure of the MEA are the same as those of the first example, and the structure of the fuel cell stack 15 is also the same as that of the first example. Other conditions are also the same if not mentioned specifically below. In the present example, the configuration of the housing 14 was devised as mentioned below.

As for the fourth example, the fan 51 was mounted behind a right column of the two columns of the fuel cells 11 as shown in FIG. 9. The partition 26 for separating the airflow was provided between the right side column of the fuel cells and a left side column thereof. An exhaust port of the fan 51 was provided to be orthogonal to an air flowing direction and the air was flown into the left side column. For this reason, in the power generation, outside air is flown directly to the right side column and the cathode exhaust: of the right side column is flown to the left side column.

### First Comparison Example

The structure of the fuel cell system used in a first comparison example will be described below. The manufacturing method and the structure of the MEA are the same as those of the first exemplary embodiment, and the structure of the fuel cell stack 15 is also the same as that of the first example. Other conditions are also the same if not mentioned specifically below.

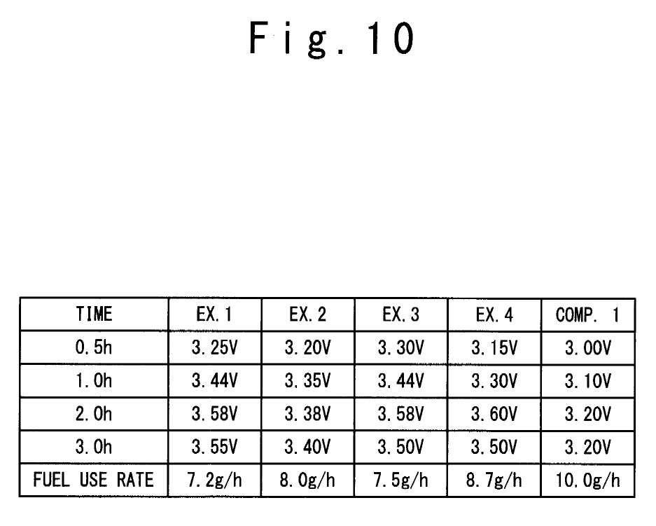

As for the first comparison example, a usual blowing method without the duct 80 was employed as shown in FIG. 10. For this reason, the outside air is constantly drawn into the stack intake opening section 24 and the cathode exhaust is directly discharged to the outside through the stack exhaust opening section 25 and the fan 51.

### (Experimental Result)

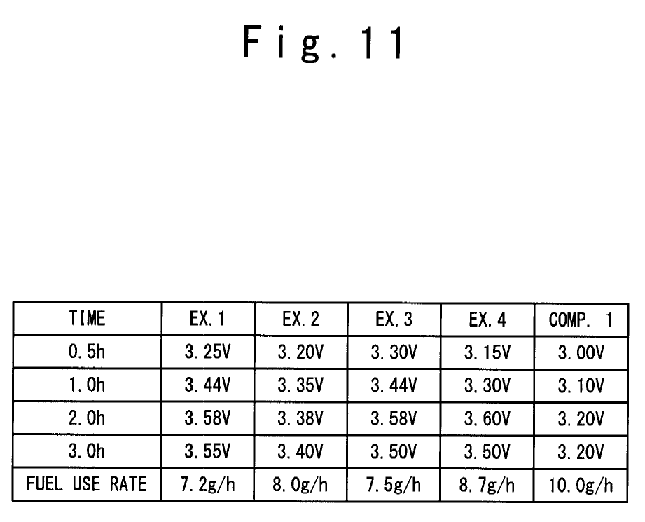

As for the first to fourth examples and the first comparison example, following tests of the power generation were carried out. By supplying 10 vol % aqueous methanol solution for 1000 ml to the fuel cell stack 15 in the flow rate of 10 ml/min. in circulation, the tests of the power generation were carried out for three hours at a current value corresponding to the current density of 100 mA/cm² in the atmosphere of 25° C. and 50%, and variation of voltage at that time was monitored after 0.5, 1, 2, and 3 hours. FIG. 11 shows results in each condition.

In the first comparison example, the power generation was stable from beginning to end. However, a voltage was lower compared to first to fourth examples because the MEA 13 in an upper stream of airflow tends to be cooled and the cathode 31 is in low humidity and slightly dried. In addition, since the cathode exhaust was directly exhausted to the outside, a rate of fuel use was 10.0 g/hr which was inferior to an example mentioned below.

In the first example, temperature of the MEA 13 positioning in upstream of airflow sufficiently rose and humidity of the MEA become moderate since the cathode exhaust: of high humidity warmed by passing through the cathode 31 is directly resupplied, and thus an voltage totally become high. Also, as for the rate of fuel use, since the humidity of the airflow space 29 sufficiently become high, evaporation of cathode product: water and volatilization of fuel component through the MEA 13 could be suppressed, resulting in economical consumption of the supplied fuel.

As for the second example, the same result as that of the first example was obtained as a trend. However, temperature rising was suppressed because the duct side wall 82 has notches and an voltage itself become slightly lower compared to the first example. However, since an absolute amount of moisture in the airflow space 29 was reduced, dew condensation in the housing 14 was suppressed and lowering of the voltage in the time of 2.0 hr to 3.0 hr did not occur. In addition, compared to the first comparison example, the rate of fuel use showed a good value (small value), compared to the first comparison example but was slightly inferior to the first example. The reason why the rate was inferior to that of the first example would be in that the cathode exhaust is easily exhausted to the outside because the duct side wall 82 has notches.

In the third example, almost the same result as that of the first example was obtained. However, a little bit of lowering of a voltage was found in a time of 2.0 hr to 3.0 hr. It can be considered that certain dew condensation occurred since the fan 51 does not directly blow air in that configuration. As for the rate of fuel use, almost the same value as that of the first example was obtained since the cathode exhaust is circulated.

In the fourth example, an upstream of airflow was slightly dried in an early stage of the power generation. However, a humidity condition suitable for the power generation in association with continuation of the power generation was achieved. For that reason, a stable voltage was obtained after 1.0 hr. However, since dew condensation was increased in a downstream portion than the fan 51 in association with the continuation of the power generation, the voltage was lowered in a time of 2.0 hr to 3.0 hr in spite that the voltage was totally high. Since the cathode exhaust is circulated, the rate of fuel use was slightly inferior to the first example but was sufficiently superior to the first comparison example.

As described above, when using the method of the present invention shown in the first to fourth examples, a total output becomes high since desiccation in the cathode 31 is reduced and a stack temperature becomes high. For this reason, a necessary voltage can be obtained in a lower electric current. Further, since the volatilization of cathode product water and fuel volatilization through the MEA is suppressed, generation time per used fuel is improved. As a result, more stable power generation than the conventional method can be continued for a long time. This method is available for a fuel cell stack requiring large power consumption such as the planar stack type fuel cell and allows the fuel cell being mounted on a portable apparatus requiring a relatively high output such as the PC.

1. A fuel cell system comprising:
a fuel cell stack comprising a plurality of fuel cells arranged on an identical plane;
a housing configured to cover said fuel cell stack above a surface of said fuel cell stack through an airflow space;
an airflow generating section configured to form airflow in said airflow space; and
a blowing path provided such that exhaust gas exhausted from said airflow space is introduced into said airflow space again via said airflow generating section.

2. The fuel cell system according to claim 1, wherein said airflow space is opened to a stack intake opening section configured to take oxidant gas into said airflow space and a stack exhaust opening section configured to exhaust the exhaust gas from said airflow space,
wherein said blowing path is provided to connect said stack exhaust opening section with at least a part of said stack intake opening section via said airflow generating section,
wherein said airflow space communicates with said blowing path in the part of said stack intake opening section and communicates with outside at another part of said stack intake opening section, and
wherein the exhaust gas from said stack exhaust opening section and external air are supplied from said stack intake opening section to said airflow space.

3. The fuel cell system according to claim 1, wherein said airflow generating section comprises a fan.

4. The fuel cell system according to claim 1, wherein said fan is arranged in a planar direction of said fuel cell stack and in parallel to said fuel cell stack.

5. The fuel cell system according to claim 1, wherein said plurality of fuel cells are arranged in a plurality of columns,
said airflow space is divided by a partition configured to make the airflow uniform in the plurality of columns,
said blowing path is provided such that the exhaust gas exhausted from one of the plurality of columns is supplied to another of the plurality of columns via said airflow generating section.

6. The fuel cell system according to claim 5, wherein said airflow generating section comprises a fan,
wherein said airflow generating section, said fuel cell stack, and said blowing path are arranged on an identical plane,
wherein said airflow generating section, said fuel cell stack, and said blowing path are housed in a single housing, and
wherein said airflow space communicates with an intake section of said airflow generating section in said one column and communicates with an exhaust section of said airflow space in said another column.
